(19) United States
(12) Patent Application Publication
(10) Pub. No.: US 2015/0085323 A1
(43) Pub. Date: Mar. 26, 2015

(54) Application Form Processing

(71) Applicant: Kaoru Watanabe, Sunnyvale, CA (US)

(72) Inventor: Kaoru Watanabe, Sunnyvale, CA (US)

(73) Assignee: Ricoh Company, Ltd., Tokyo (JP)

(21) Appl. No.: 14/037,598

(22) Filed: Sep. 26, 2013

(51) Int. Cl. H04N 1/32; H04N 1/00; H04N 1/21

(52) U.S. Cl. CPC H04N 1/32037; H04N 1/2187; H04N 1/00408; H04N 1/32133; H04N 2201/0093; H04N 2201/0087; H04N 2201/3207
USPC 358/402

(57) ABSTRACT

An end-to-end approach for processing application forms allows a user to have a plurality of printed application forms scanned at scanning device, and have the scanned document data generated by the scanning device automatically processed by an application form processing service implemented on a network. The application form processing service causes application form data to be obtained from the scanned document data, for example by using one or more data capture services, and the application form data to be stored on network storage and/or a database management system. Users may access and manage the application form data stored on the network storage and/or a database management system via client devices. This may include using a search tool to locate particular application form data of interest and editing, deleting, or adding to the particular application form data.

### FIELD

Embodiments relate generally to an approach for processing application forms.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Current approaches for processing application forms have significant limitations. For example, application forms for education programs are typically printed and distributed to candidate students. Candidate students complete the printed application forms and mail or scan and email the completed application forms to the host education institution. The host education institution reviews the completed applications and manually enters the data from the completed application forms into an electronic system, such as a word processing program or an electronic spreadsheet program. This approach is very labor intensive and susceptible to errors.

### SUMMARY

An approach is provided for processing application forms. An application form processing service executing on a network device receives, over one or more communications networks from a scanning device, scanned document data that represents a plurality of education application forms scanned by the scanning device. The application form processing service causes the scanned document data to be processed to identify application form data contained in the plurality of education application forms scanned by the scanning device. The application form data includes one or more application form fields contained in the plurality of education application forms. The application form processing service causes the application form data to be stored in a database management system and the application form processing service causes at least a portion of the application form data to be provided to the client device.

### BRIEF DESCRIPTION OF THE DRAWINGS

In the figures of the accompanying drawings like reference numerals refer to similar elements.

FIG. 1 is a block diagram that depicts an example arrangement for processing application forms.

FIG. 2 is a flow diagram that depicts an approach for application form processing.

FIG. 3 is a message ladder diagram that depicts the exchange of messages between various elements of an arrangement for processing application forms according to an embodiment.

FIG. 4 is a block diagram that depicts an example educational application form 400.

FIG. 5A depicts an example user interface provided by an application program that allows user to enter information for new educational events and for printing application forms.

FIG. 5B is a table that stores educational event data.

FIG. 5C is an example user interface that allows a user to search for student information by event name or ID, school name, student name or other information.

FIG. 5D depicts an example results screen that depicts the student information for three students participating in a particular education program.

FIG. 6 depicts an example operation panel of a scanning device.

FIG. 7 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. APPLICATION FORM PROCESSING ARCHITECTURE
   A. Scanning Devices
   B. Client Devices
   C. Database Management System
   D. Network Services
III. MERGING SCANNED DOCUMENT DATA
IV. ACCESSING AND USING APPLICATION FORM DATA
   A. Browsing Student Information
   B. Creating Newsletters
   C. Statistical Analysis
V. IMPLEMENTATION MECHANISMS

### I. Overview

An approach is provided for processing application forms. The approach is an end-to-end approach that allows a user to have a plurality of printed application forms scanned at scanning device, and have the scanned document data generated by the scanning device automatically processed by an application form processing service implemented on a network. The application form processing service causes application form data to be obtained from the scanned document data, for example by using one or more data capture services, and the application form data to be stored on network storage and/or a database management system. Users may access and manage the application form data stored on the network storage and/or a database management system via client devices. This may include using a search tool to locate particular application form data of interest and editing, deleting, or adding to the particular application form data. The approach provides a user-friendly experience for processing application forms from disparate sources.

### II. Application Form Processing Architecture

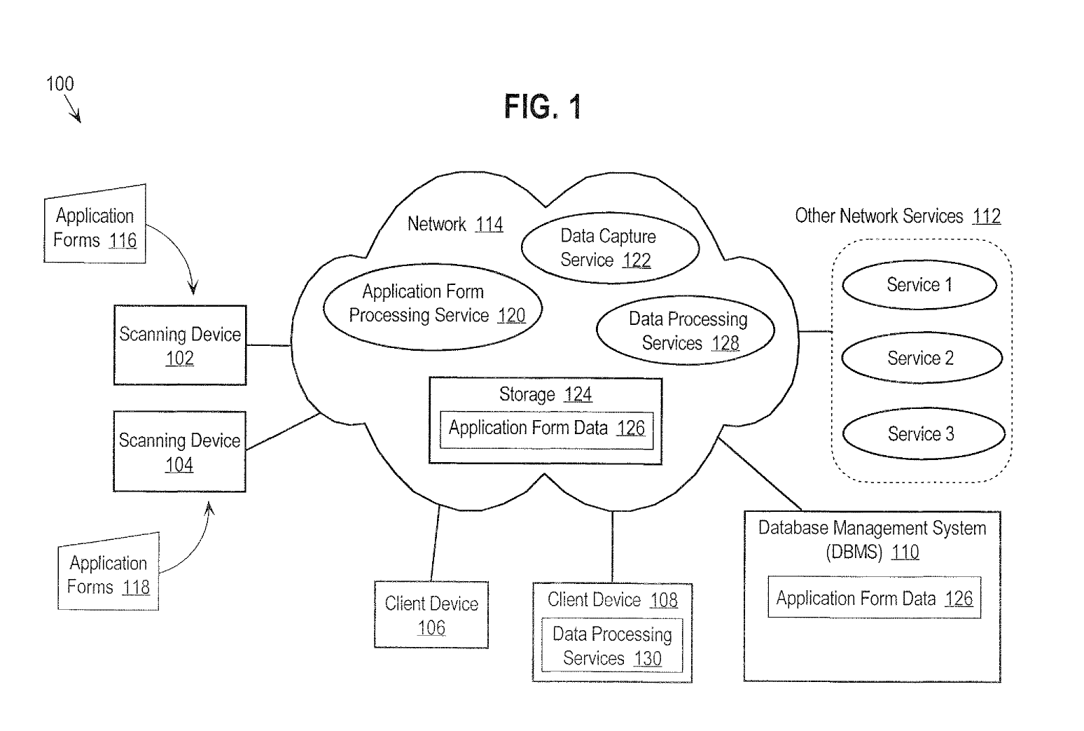

FIG. 1 is a block diagram that depicts an example arrangement 100 for processing application forms. Arrangement 100 includes scanning devices 102, 104, client devices 106, 108, a database management system 110 and other network services 112 communicatively coupled via a network 114. Network 114 may include any number of network connections, for example, one or more Local Area Networks (LANs), Wide Area Networks (WANs), Ethernet networks or the Internet, and/or one or more terrestrial, satellite or wireless links. The elements depicted in arrangement 100 may also have direct communications links that may vary depending upon a particular implementation.

### A. Scanning Devices

Scanning devices 102, 104 are any type of device that includes the capability to scan one or more printed documents and generate scanned document data that represents the one or more printed documents. The scanned document data may be in a variety of formats, depending upon a particular implementation. One example format is the portable document format (PDF) by Adobe Systems, Inc. Scanning devices 102 may also include a capability to convert scanned document data from a non-text format, such as PDF, to a text-based format, using for example, optical character recognition (OCR). Scanning device 102 may also include the capability to transmit the scanned document data to another location or device, for example, to a computer connected to the scanning device 102 or over a network to a network device. Examples of scanning devices 102, 104 include, without limitation, a scanner and a multi-function peripheral that includes one or more functions in addition to scanning, such as printing, copying, faxing, etc. Although embodiments are described herein in the context of two scanning devices 102, 104, embodiments are applicable to any number and types of scanning devices.

Scanning devices 102, 104 may include a user interface, such as an operation panel, screen, touchscreen, etc., for displaying information to users and receiving user input from users. The user interface may include controls that allow a user to scan application forms 116, 118, respectively. The controls may include physical controls, such as buttons and actuators, as well as graphical user interface (GUI) objects displayed on the user interface. The user interface for scanning devices 102, 104 may also allow a user to specify a destination for scan data generated by scanning devices 102, 104. Example destinations include, without limitation, a device name, network address, or email address.

### B. Client Devices

Client devices 106, 108 may be any type of client device, depending upon the particular implementation. Example client devices include, without limitation, personal or laptop computers, workstations, tablet computers, personal digital assistants (PDAs) and telephony devices such as smart phones. Client devices 106, 108 may include applications including, for example, Web browsers and other client-side applications, such as data processing services 130 that are described in more detail hereinafter.

### C. Database Management System

Database Management System (DBMS) 110 may be implemented by any type of database management system for storing and managing application form data 126. DBMS 110 may include volatile storage, non-volatile storage, or any combination of volatile storage and non-volatile storage, depending upon a particular implementation.

### D. Network Services

Application form processing service 120 is a service that is configured to manage the processing of scan data as described herein. This includes receiving, over network 114 from scanning devices 102, 104, scanned document data that represents a plurality of educational application forms scanned by scanning devices 102, 104. Application form processing service 120 causes application form data 126 to be obtained from the scanned document data and stored in storage 124 and/or in DBMS 110. This may include application form processing service 120 invoking data capture service 122 or other network services 112 to perform data capture optical character recognition (OCR) on the scanned document data to obtain application form data 126. Application form data 126 may include data that indicates one or more data fields and their contents included on the application forms 116, 118 scanned by scanning device 102, 104. For example, in the context of education application forms, information about a student applying for an education program may be obtained. This may include, for example the name and contact information for an applicant and the applicant's parents or guardians and medical history information.

### III. Application Form Processing

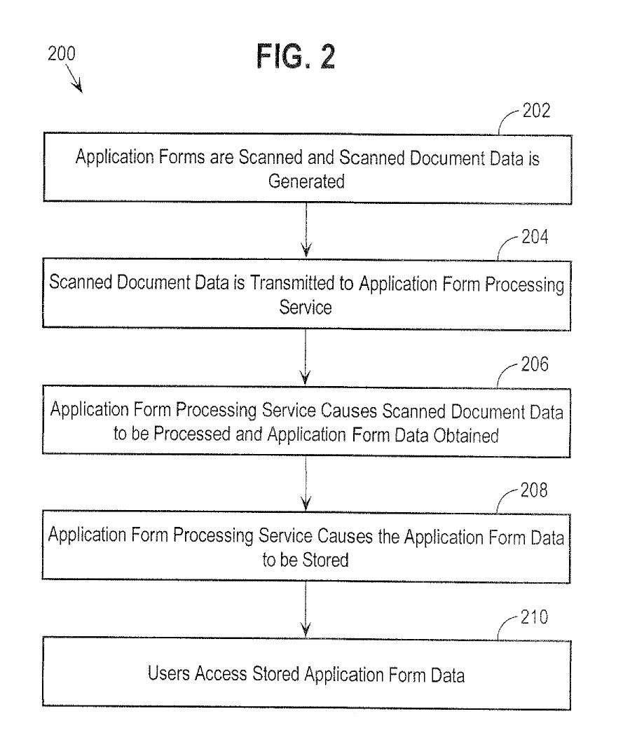

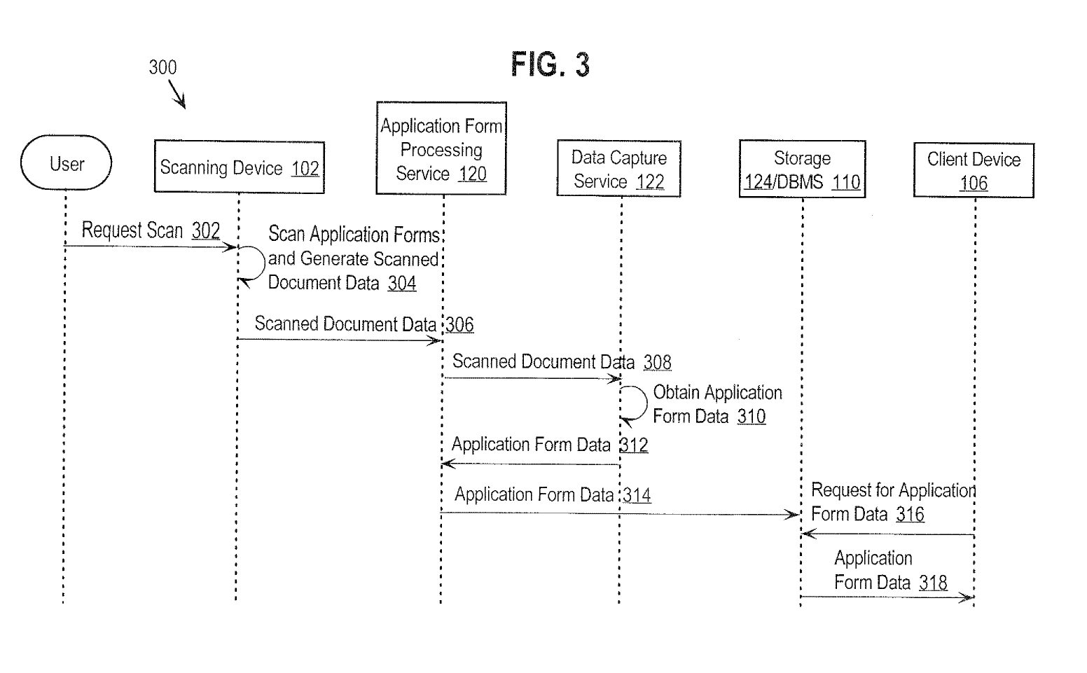

FIG. 2 is a flow diagram 200 that depicts an approach for application form processing, according to an embodiment. The steps depicted in FIG. 2 provide an overview of an embodiment and are described in more detail hereinafter with respect to the message ladder diagram of FIG. 3. In step 202, application forms are scanned and scanned document data is generated. In step 204, the scanned document data is transmitted to an application form processing service. For example, scanning devices 102, 104 cause the scanned document data to be transmitted over network 114 to application form processing service 120.

In step 206, the application form processing service causes the scanned document data to be processed to obtain application form data. For example, application form processing service 120 may use data capture service 122 and other services to obtain, from the scanned document data, particular fields and their contents on the application forms 116, 118. In step 208, the application form processing service causes the application form data to be stored. For example, application form processing service 120 may cause the application form data to be stored on storage 124 and/or on DBMS 110. In step 210, a user accesses the stored application form data. For example, a user of client device 106 may access application form data 126 in storage 124 or in DBMS 110 via data processing services 128. As another example, a user of client device 108 may use data processing services 130 to access application form data 126 in storage 124 or in DBMS 110.

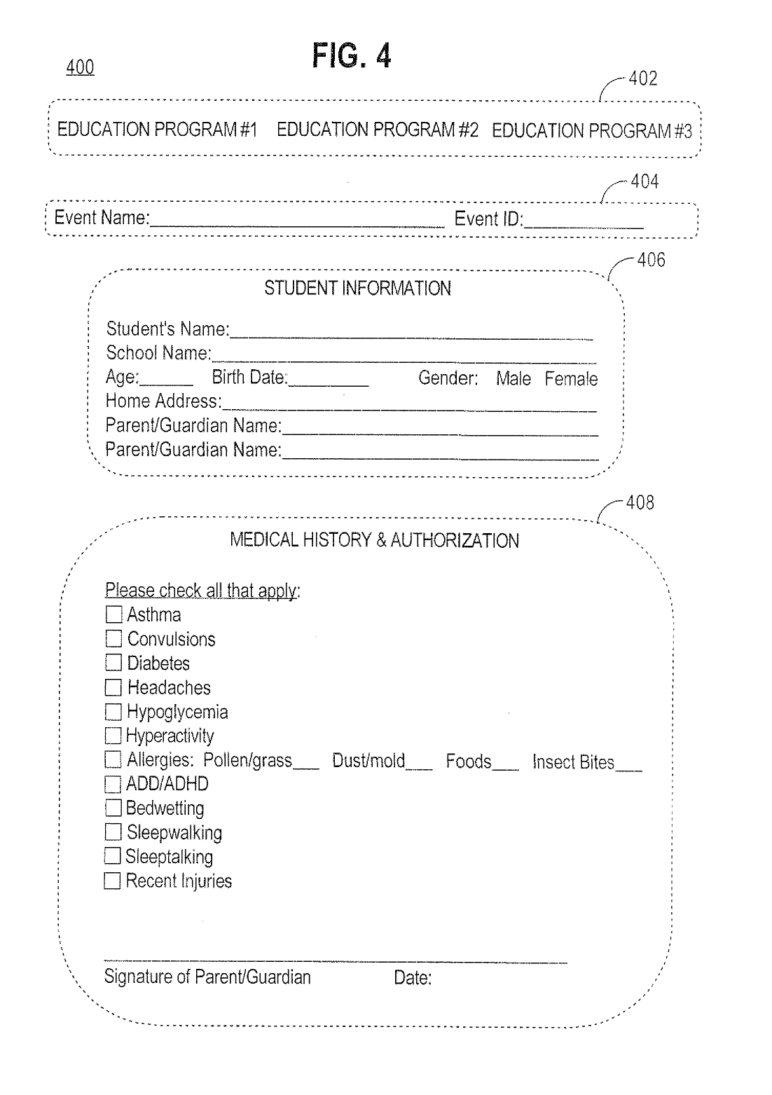

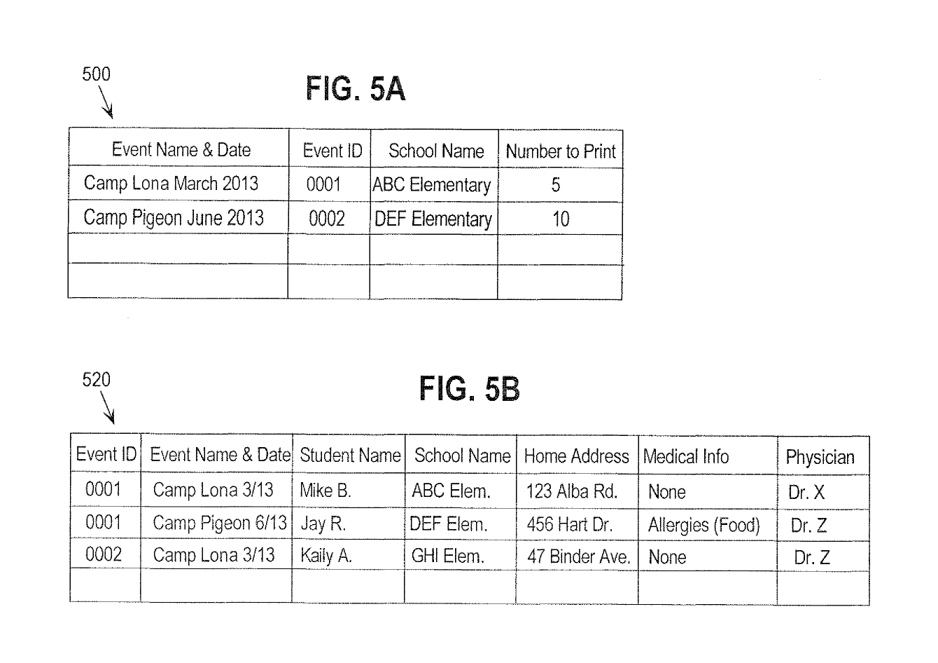

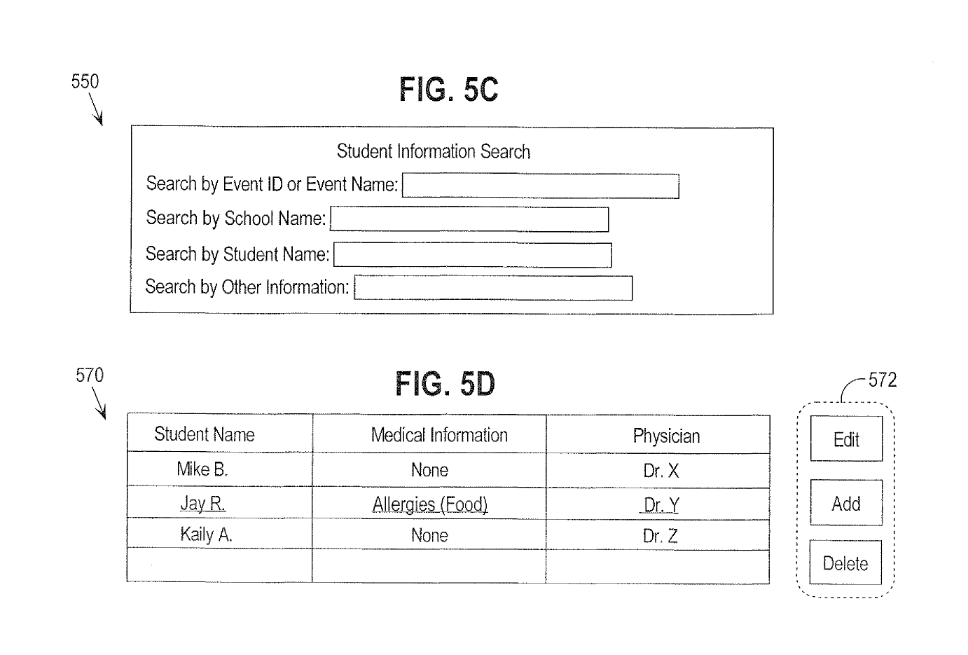

FIG. 3 is a message ladder diagram 300 that depicts the exchange of messages between various elements of arrangement 100 for processing application forms according to an embodiment. A user accesses scanning device 102 and in step 302, requests that application forms 116 be scanned. One example type of application form is an application form for an education program, where the application forms request an applicant supply personal contact information and medical history information. FIG. 4 is a block diagram that depicts an example educational application form 400. Form 400 may be created manually, for example, using a word processing program. According to one embodiment, form 400 may be automatically created by an application program, such as application form processing service 120, data processing services 128, other network services 112 or by a DBMS application program. The application program may include a user interface that allows a user to select and arrange the fields that are included on form 400. The user interface may also allow the user to enter information to be included in some of the fields, for example, a school name or education program name, an event name and event ID, and print a specified number of copies of form 400. FIG. 5A depicts an example user interface 500 provided by an application program that allows user to enter information for new educational events and for printing application forms. Some of the information on form 400 may be automatically specified by the application program. For example, the application program may automatically generate and assign an event ID to the event. According to one embodiment, the application program may also create an event record on storage 124 and/or in DBMS 110.

In the present example, form 400 identifies three education programs 402 that may be selected by the applicant, for example, by circling one or more of the names of the education programs 402. Form 400 also includes an event information section 404 that allows a user to specify the name of an event and an event ID, such as a number, code, abbreviated name, etc. Form 400 also includes a student information section 406 in which general information about the student applicant is provided. Form 400 further includes a medical history & information section 408 in which medical history and authorization information is provided for the student applicant. Form 400 is provided as an example and embodiments are not limited to the particular example form 400 depicted in FIG. 4.

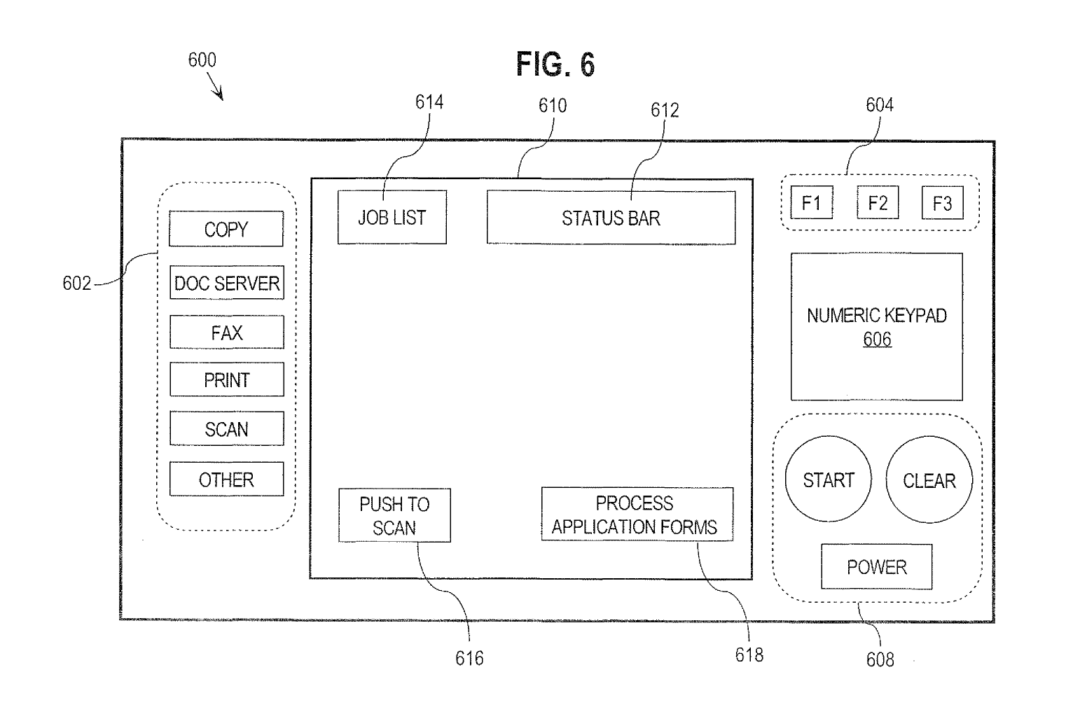

FIG. 6 depicts an example operation panel 600 of scanning device 102. Operation panel 600 includes a set of user interface controls 602 for activating functions of scanning device 102. The user interface controls on operation panel 600 may be graphical, non-graphical, i.e., buttons, switches, etc., or a combination of graphical and non-graphical. The functions depicted in FIG. 6 include copy, connect to a document server, fax, print, scan and other functions. Selecting the “Other” option may provide access to additional functions, such as functions that are less commonly selected by users. These functions are provided as examples of typical functions that may be implemented on a scanning device that is an MFP, but the functions implemented on any particular scanning device may vary depending upon the implementation and the approaches described herein are not limited to scanning device 102 supporting a particular set of functions. Operation panel 600 also includes a set of function buttons 604 that may be assigned to various functions, or combinations of functions, provided on scanning device 102. For example, function button 604 “F1” may be personalized for a particular user and invoke a series of functions that are often used by the user, such as scan-to-email plus OCR and archival storage. Operation panel 600 also includes a numeric keypad 606 and a set of user controls 608 for toggling the power of scanner device 102, starting a function and clearing a selected function. These are examples of the user controls that are typically included on a scanning device. More or fewer user controls may be provided, depending upon a particular implementation.

Operation panel 600 also includes a GUI 610 for displaying information and receiving user input. GUI 610 may be a touch screen that is capable of detecting user selection of icons and GUI objects displayed on GUI 610. GUI 610 may be generated based upon computer hardware, computer software or any combination of computer hardware and computer software. For example, GUI 610 may be generated based upon firmware or software installed on scanning device 102. As another example, GUI 610 may be implemented by instructions stored external to scanning device 102 that are retrieved and executed by scanning device 102. For example, scanning device 102 may include a Web browser that processes Web pages retrieved from a network service via network 114. The Web browser may transmit a HTTP request in response to selection of the scanning function on the set of UI controls 602 or upon startup of scanning device 102. In this way, GUI 610 may be updated remotely at any time before GUI 610 is loaded onto scanning device 102. Also, by relying on a network service for GUI 610, scanning device 102 is removed from the responsibility for persistently storing, updating, or otherwise maintaining GUI 610.

In the present example, GUI 610 includes a status bar GUI object 612 that displays status information, such as the status of scanning device 102 or the status of one or more scan jobs. GUI 610 also includes a job list GUI object 614 which, when selected, displays a list of jobs associated with the scanning device 102, for example, scan jobs that have been processed and/or scan jobs that are currently being processed. GUI 610 may also include a “Push-to-Scan” button 616 that invokes a simple scan operation. GUI 610 includes a “Process Application Forms” button which, when selected, initiates the end-to-end process described herein for processing application forms. For example, a user provides application forms 116 to scanning device 102 and selects the “Process Application Forms” button 618 which, in step 304, causes scanning device 102 to scan the application forms 116 and generate scanned document data that is then processed as described hereinafter. The scanned document data may be in a wide variety of forms that may vary depending upon a particular implementation. Example forms include, without limitation, PDF, JPG, GIF, TIFF, or DOC. Selecting the “Process Application Forms” button 618 may allow a user to specify commands to be processed by application form processing service 120. For example, a user may be allowed to specify recipients of application form data 126, such as client devices 106, 108, other network services 112, etc. Alternatively, application form processing service 120 may be configured, for example by an administrator, to transmit application form data 126 to particular recipients.

In step 306, scanning device 102 causes the scanned document data to be transmitted to application form processing service 120. The user of scanning device 102 may actively select application form processing service 120. Alternatively, scanning device 102 may be configured to automatically send the scanned document data to application form processing service 120 in response to selection of the “Process Application Forms” button 618. For example, an administrator may configure scanning device 102 to transmit the scanned document data to a network address and/or port number of application processing service 120. Command data that specifies recipients of application form data 126 may also be transmitted to application form processing service 120, either with or separate from the scanned document data.

In step 308, application form processing service 120 transmits the scanned document data to data capture service 122. In step 310, data capture service 122 processes the scanned document data to obtain application form data represented in the scanned document data. The application form data may include data fields, for example for personal information and medical history, on the application forms 116 scanned by scanning device. Data capture service 122 may be configured with data capture OCR functionality to obtain the application form data represented in the scanned document data. One example is ABBYY FlexiCapture by ABBYY USA. Data capture service 122 may use one or more templates in conjunction with the data capture OCR functionality to obtain the application form data. The application form data may be in a wide variety of data formats that may vary depending upon a particular implementation and the approaches described herein are not limited to the application form data being in any particular format. According to one embodiment, the application form data 126 is in a format suitable for use by DBMS 110 and end applications, such as spreadsheet programs, custom user programs, etc. Example data formats include, without limitation, text, ASCII, or any type of database file format.

In step 312, data capture service 122 transmits the acquired application form data to application form processing service 120. In step 314, application form processing service 120 causes the application form data to be stored on storage 124 and/or DBMS 110 to allow the application form data to be made available to client devices 106, 108. The application form data 126 may be stored on storage 124 or in DBMS 110 in an arrangement and format that allows the application form data 126 to be readily retrieved by client devices 106, 108. Application form processing service 120 may implement commands supported by an application program interface (API) of storage 124 or may issue commands to DBMS 110 to cause the application form data to be stored on storage 124 and/or DBMS 110, respectively. FIG. 5B is a table 520 that stores educational event data. In this example, each row of table 520 corresponds to a student and includes information for the student from form 400, including the event ID, the event name and date, the student's name, the school name, the student's home address, medical information, such as allergies, and the name of the student's physician. Additional information may be included in table 520 depending upon a particular implementation. Application form data 126 may be automatically sorted and indexed when stored on storage 124 and/or DBMS 110. For example, application form data 126 may be sorted by school name, education program or event name, event ID, etc.

In step 316, client device 106 requests the form data from storage 124 or DBMS 110. In step 318, the application form data is provided to client device 106. The process of a client device obtaining application form data as depicted in steps 316, 318 is described in more detail hereinafter.

### IV. Accessing and Using Application Form Data

Once application form data 126 has been stored in storage 124 and/or in DBMS 110, the application form data 126 may be accessed by client devices 106, 108 using a wide variety of techniques that may vary depending upon a particular implementation. For example, client device 106 may access application form data 126 via data processing services 128. Client device 106 may be configured with a client-side application that communicates with data processing services 128 to retrieve and update application form data 126. The client-side application may be a proprietary software application or may be, for example, a Web browser that provides a Web-based user interface. Alternatively, as depicted in FIG. 1, client device 108 includes data processing services 130 for accessing application form data 126 in storage 124 and/or in DBMS 110.

Embodiments are not limited to the context of a client device having to request application form data 126. According to an embodiment, application form processing service 120 may cause the application form data 126 to be automatically provided to an application on a client device without requiring that the application explicitly request the application form data 126. For example, after application form processing service 120 receives the application form data 126 from the data capture service 122 in step 312, the application form processing service 120 may cause the application form data 126 to be provided to an application on client devices 106, 108, such as data processing services 130. Application form processing service 120 may also automatically provide application form data 126 to other network services 112. For example, network services 112 may include an archival service and application for processing service 120 may automatically provide application form data 126 to the archival service. This may be in addition to automatically providing application form data 126 to client devices. Application form processing service 120 may be configured, for example by an administrator, to automatically cause application form data 126 to be supplied to a client device and/or other network services 112. Alternatively, these actions may be specified by a user at scanning device 102. For example, a user may select one or more controls or GUI objects on scanning device 102 to select particular recipients of application form data 126 at the time the user scans application forms 116. In this example, command data that indicates the user's commands may be transmitted to application form processing service 120 either separate from or with the scanned document data. The application form processing service 120 processes the command data to know where to transmit application form data 126.

### A. Browsing and Updating Student Information

According to one embodiment, a user interface is provided to allow users, such as school administrators and teachers, to access, including viewing and updating, the application form data 126 stored on storage 124 and/or in DBMS 110. The user interface may be provided by a client-side component, such as a database application Web browser. The user interface may allow a user to search for student information based upon various search criteria, such as event ID, school name, or student name. FIG. 5C is an example user interface 550 that allows a user to search for student information by event name or ID, school name, student name or other information. For example, a teacher or administrator may enter the name of a particular event, such as “Camp Lona March 2013” to search for all of the student participants. Thus, although application form data 126 may include data from many different schools and programs, user interface 550 allows users to easily retrieve information pertaining to particular schools and/or particular events or programs.

FIG. 5D depicts an example results screen 570 that depicts the student information for three students participating in a particular education program. The column headings, i.e., “Student Name”, “Medical Information” and “Physician” may be selectable to sort the contents of results screen 570 by the selected column heading. For example, selecting the “Student Name” column heading causes the contents of results screen 570 to be sorted alphabetically (reverse or forward). Data within results screen 570 may include active links. For example, in the example depicted in FIG. 5D, the medical information for student “Jay R.” indicates that he had food allergies. Accordingly, the data contained in this row contains links that may be selected. Selecting the student name “Jay R.” may cause additional information about the student, such as contact information, to be displayed, for example, in a dialog box. Selecting “Allergies (Food)” may cause additional information about the food allergies to be displayed, for example, additional information describing particular foods for which the student is allergic. Selecting “Dr. Z” may cause additional information, such as contact information for Dr. Z, to be displayed. This approach provides a user-friendly approach for teachers or school administrators to obtain information about students participating in an education program. For example, a teacher may use a hand-held device, such as a smart phone, to quickly and easily obtain information for the students participating in a particular education program. The approach also allows medical or other personnel to quickly and easily obtain medical information about students participating in an education program, including, for example, information about allergies, medications being taken by students, etc. Contact information for students' physicians is also made readily available to teachers, administrators and medical personnel.

Users may also manage the application form data 126 displayed on the user's client device. For example, a set of controls 572, allows a user to edit, add or delete data in results screen 570. The edit control 572 allows a user to select a field in results screen 570, select the edit control 572 and then update the value in the selected field. The add control 572 allows a user to add a new student in results screen 570 and the delete control 572 allows a user to select and delete an existing student from results screen 570. Changes to data made via results screen 570 may automatically be saved to storage 124 and/or DBMS 110.

### B. Creating Newsletters & Marketing Materials

Application form data 126 may also be used in other contexts, for example, for use with newsletters or marketing materials. The application form data 126 may be used to generate statistical information to be included in newsletters or marketing materials. For example, the statistical information may be used to indicate the student participation, for example, total student participation, student participation by school, student participation by event, as well as other information, such as the number of students with particular medical conditions, etc. Contact information, such as email addresses, from the application form data 126 may also be used to distribute newsletters or marketing materials.

### C. Statistical Analysis

Application form data 126 may also be used for statistical analysis. For this purpose, application form data 126 may be exported into a wide variety of formats, such as excel, comma separated, etc., that may vary depending upon a particular implementation. The application form data 126 may be used to analyze student participation at past events and for forecasting student participation at future events. The results of the statistical analysis may be used to create reports, bar graphs, geographical maps, etc. For example, bar charts may be created to depict the number of occurrences of particular medical conditions, such as allergies. As another example, an application may use application form data 126 to generate a geographical map that depicts the locations of education programs and specifies the number of students in each education program. The geographical map may also depict where the participating students are from, e.g., their home towns. The results of the forecasting may also be used to print a number of applications based upon an expected number of participants. This can reduce waste and processing time.

Application form data 126 may be stored incrementally, i.e., in a manner where data is stored that indicates the changes in application form data 126 since the last time application form data 126 was stored. For example, DBMS 110 may store data that indicates the changes made to application form data 126 since the last time that the application form data 126 was updated in DBMS 110. This allows incremental data to be provided to a client device for processing. For example, suppose that client device 108 initially obtains the application form data 126 from DBMS 110. Additional applications 118 are then processed and the application form data 126 in DBMS 110 is updated to include application form data for the additional applications 118. Client device 108 again requests the application form data 126 from DBMS 110. DBMS 110 may be configured to allow client device 108 to request to receive all application form data 126 stored in DBMS 110. Alternatively, client device 108 may receive only the updates to the application form data 126 since the time when client device 108 last obtained the application form data 126 from DBMS 110. In the present example, this would include only the new application form data for additional applications 118. This feature allows client devices to acquire and process smaller amounts of data, which reduces the amount of time and computational resources required to process application form data.

### D. Updating Application Forms

Application form data 126 may also be used for updating application forms. For example, a review of application form data 126, or of statistical data generated based upon application form data 126, may indicate that it would be helpful to change on one more application forms. The changes may include, for example, editing, adding or removing fields. According to one embodiment, application form processing service 120 includes a capability to allow users, such as an administrator, to update application forms. This may include providing a user interface, such as a graphical user interface, that allows a user to view a particular application form and select application form fields in the particular application form. The user can then perform an action on the selected application form fields, including editing and deleting the selected application form fields. Editing a selected application form field may include moving, reformatting or editing the content of the selected application form field. Application form processing service 120 maintains application forms, for example on storage 124. Application form processing service 120 provides a user interface for accessing and printing application forms, as well as managing application forms as previously described herein.

### V. Implementation Mechanisms

Although the flow diagrams of the present application depict a particular set of steps in a particular order, other implementations may use fewer or more steps, in the same or different order, than those depicted in the figures.

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

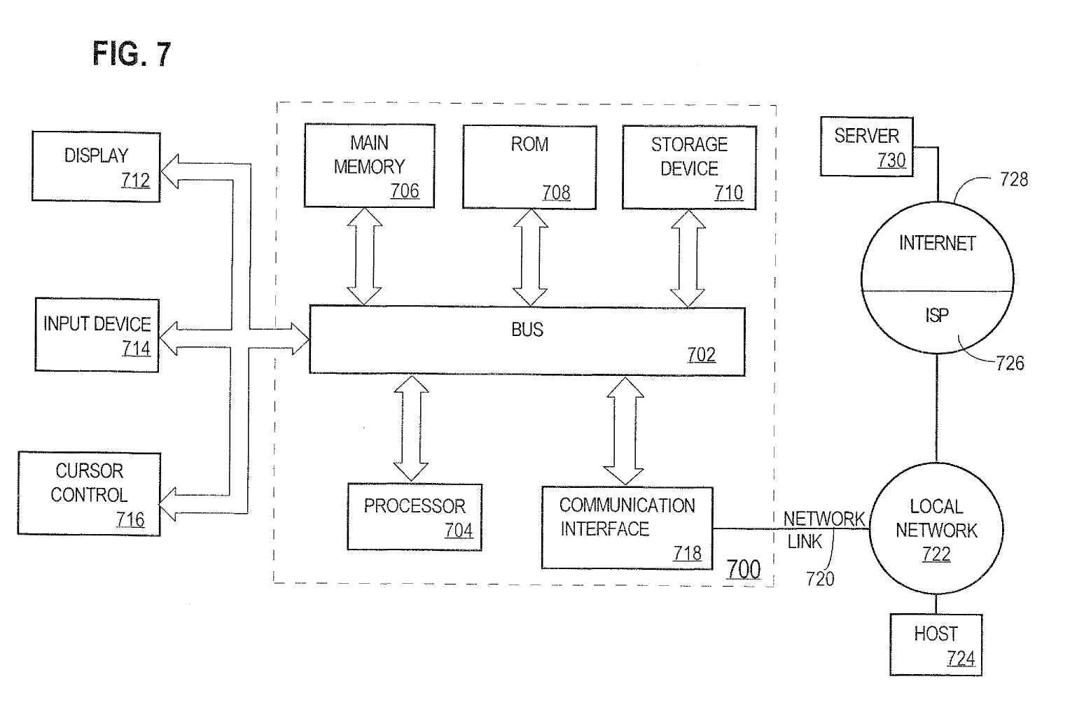

FIG. 7 is a block diagram that depicts an example computer system 700 upon which embodiments of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic or computer software which, in combination with the computer system, causes or programs computer system 700 to be a special-purpose machine. According to one embodiment of the invention, those techniques are performed by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 700, various computer-readable media are involved, for example, in providing instructions to processor 704 for execution. Such a medium may take many forms, including but not limited to, non-volatile media and volatile media. Non-volatile media includes, for example, optical or magnetic disks, such as storage device 710. Volatile media includes dynamic memory, such as main memory 706. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is, and is intended by the applicants to be the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. One or more non-transitory computer-readable media storing instructions which, when processed by one or more processors, cause:
an application form processing service executing on a network device receiving, over one or more communications networks from a scanning device, scanned document data that represents a plurality of education application forms scanned by the scanning device;
the application form processing service causing the scanned document data to be processed to identify application form data contained in the plurality of education application forms scanned by the scanning device, wherein the application form data includes one or more application form fields contained in the plurality of education application forms;
the application form processing service causing the application form data to be stored in a database management system; and
the application form processing service causing at least a portion of the application form data to be provided to the client device.

2. The one or more non-transitory computer-readable media as recited in claim 1, wherein the application form processing service causing the scanned document data to be processed to identify application form data contained in the plurality of education application forms scanned by the scanning device includes the application form processing service invoking a data capture network service to identify the application form data contained in the plurality of education application forms scanned by the scanning device.

3. The one or more non-transitory computer-readable media as recited in claim 1, further storing additional instructions which, when processed by the one or more processors, causes generating and transmitting to the client device graphical user interface data which, when processed at the client device, causes a graphical user interface to be generated at the client device to allow a user to view and update the application form data.

4. The one or more non-transitory computer-readable media as recited in claim 1, wherein the application form processing service causing at least a portion of the application form data to be provided to the client device is performed in response to one or more of command data received from the scanning device that specifies the client device as a recipient of the application form data or a request from the client device.

5. The one or more non-transitory computer-readable media as recited in claim 1, further storing additional instructions which, when processed by the one or more processors, causes the application form processing service to cause at least a portion of the application form data to be provided over one or more networks to one or more network services that are separate from both the scanning device and the application form processing service.

6. The one or more non-transitory computer-readable media as recited in claim 1, further storing additional instructions which, when processed by the one or more processors, causes the application form processing service to examine command data received from the scanning device that specifies a recipient of the application form data and cause the application form data to be transmitted to the recipient specified by the command data.

7. The one or more non-transitory computer-readable media as recited in claim 1, further storing additional instructions which, when processed by the one or more processors, causes generating and transmitting to the client device graphical user interface data which, when processed at the client device, causes a graphical user interface to be generated at the client device to allow a user to view, print and update one or more education application forms from the plurality of education application forms.

8. An apparatus comprising:
one or more processors; and
one or more memories storing instructions which, when processed by one or more processors, cause:
an application form processing service executing on a network device receiving, over one or more communications networks from a scanning device, scanned document data that represents a plurality of education application forms scanned by the scanning device;
the application form processing service causing the scanned document data to be processed to identify application form data contained in the plurality of education application forms scanned by the scanning device, wherein the application form data includes one or more application form fields contained in the plurality of education application forms;
the application form processing service causing the application form data to be stored in a database management system; and
the application form processing service causing at least a portion of the application form data to be provided to the client device.

9. The apparatus as recited in claim 8, wherein the application form processing service causing the scanned document data to be processed to identify application form data contained in the plurality of education application forms scanned by the scanning device includes the application form processing service invoking a data capture network service to identify the application form data contained in the plurality of education application forms scanned by the scanning device.

10. The apparatus as recited in claim 8, wherein the one or more memories store additional instructions which, when processed by the one or more processors, causes generating and transmitting to the client device graphical user interface data which, when processed at the client device, causes a graphical user interface to be generated at the client device to allow a user to view and update the application form data.

11. The apparatus as recited in claim 8, wherein the application form processing service causing at least a portion of the application form data to be provided to the client device is performed in response to one or more of command data received from the scanning device that specifies the client device as a recipient of the application form data or a request from the client device.

12. The apparatus as recited in claim 8, wherein the one or more memories store additional instructions which, when processed by the one or more processors, causes the application form processing service to cause at least a portion of the application form data to be provided over one or more networks to one or more network services that are separate from both the scanning device and the application form processing service.

13. The apparatus as recited in claim 8, wherein the one or more memories store additional instructions which, when processed by the one or more processors, causes the application form processing service to examine command data received from the scanning device that specifies a recipient of the application form data and cause the application form data to be transmitted to the recipient specified by the command data.

14. The apparatus as recited in claim 8, wherein the one or more memories store additional instructions which, when processed by the one or more processors, causes generating and transmitting to the client device graphical user interface data which, when processed at the client device, causes a graphical user interface to be generated at the client device to allow a user to view, print and update one or more education application forms from the plurality of education application forms.

15. A computer-implemented method comprising:
an application form processing service executing on a network device receiving, over one or more communications networks from a scanning device, scanned document data that represents a plurality of education application forms scanned by the scanning device;
the application form processing service causing the scanned document data to be processed to identify application form data contained in the plurality of education application forms scanned by the scanning device, wherein the application form data includes one or more application form fields contained in the plurality of education application forms;
the application form processing service causing the application form data to be stored in a database management system; and
the application form processing service causing at least a portion of the application form data to be provided to the client device.

16. The computer-implemented method as recited in claim 15, wherein the application form processing service causing the scanned document data to be processed to identify application form data contained in the plurality of education application forms scanned by the scanning device includes the application form processing service invoking a data capture network service to identify the application form data contained in the plurality of education application forms scanned by the scanning device.

17. The computer-implemented method as recited in claim 15, further comprising generating and transmitting to the client device graphical user interface data which, when processed at the client device, causes a graphical user interface to be generated at the client device to allow a user to view and update the application form data.

18. The computer-implemented method as recited in claim 15, wherein the application form processing service causing at least a portion of the application form data to be provided to the client device is performed in response to one or more of command data received from the scanning device that specifies the client device as a recipient of the application form data or a request from the client device.

19. The computer-implemented method as recited in claim 15, further comprising the application form processing service to examine command data received from the scanning device that specifies a recipient of the application form data and cause the application form data to be transmitted to the recipient specified by the command data.

20. The computer-implemented method as recited in claim 15, further comprising generating and transmitting to the client device graphical user interface data which, when processed at the client device, causes a graphical user interface to be generated at the client device to allow a user to view, print and update one or more education application forms from the plurality of education application forms.
